(19) United States
(12) Patent Application Publication
(10) Pub. No.: US 2026/0086709 A1
(43) Pub. Date: Mar. 26, 2026

(54) DYNAMIC CURSOR DISPLAY BASED ON USER GAZE

(71) Applicant: GOOGLE LLC, Mountain View, CA (US)

(72) Inventors: Diego Rivas Vetencourt, San Francisco, CA (US); Dongeek Shin, San Jose, CA (US); Ishan Chatterjee, Seattle, WA (US); Jochen Weber, San Francisco, CA (US); Li-Te Cheng, San Mateo, CA (US)

(21) Appl. No.: 18/947,828

(22) Filed: Nov. 14, 2024

Related U.S. Application Data
(63) Continuation of application No. 29/964,315, filed on Sep. 23, 2024.

(51) Int. Cl. G06F 3/0488; G06F 3/01; G06F 3/04815

(52) U.S. Cl. CPC G06F 3/0488; G06F 3/013; G06F 3/04815

(57) ABSTRACT

According to at least one implementation, a method includes identifying a gaze associated with a user of a device and identifying a first state of a gesture from the user. The method further includes causing display of a cursor over a first portion of content on a display of the device based on the gaze and the first state of the gesture. The method also includes identifying a second state of the gesture from the user and causing display of the cursor over a second portion of the content on the display based on the gaze and the second state of the gesture, the second portion being different than the first portion.

### CROSS REFERENCE TO RELATED APPLICATION

This application is a continuation of U.S. Design Application No. 29/964,315, filed Sep. 23, 2024, the disclosure of which is incorporated herein by reference in its entirety.

### BACKGROUND

An extended reality (XR) device incorporates a spectrum of technologies that blend physical and virtual worlds, including virtual reality (VR), augmented reality (AR), and mixed reality (MR). These devices immerse users in digital environments, either by blocking out the real world (VR), overlaying digital content onto the real world (AR), or blending digital and physical elements seamlessly (MR). XR devices include headsets, glasses, or screens equipped with sensors, cameras, and displays that track the movement of users and their surroundings to deliver immersive experiences across various applications such as gaming, education, healthcare, and industrial training.

### SUMMARY

This disclosure relates to systems and methods for providing a dynamic cursor on a device based on user gaze and user gestures. In at least one implementation, a device is configured to monitor a gaze associated with a user. The gaze may be monitored by the device using eye-tracking technology, which may involve at least one infrared sensor or camera to detect and analyze the movement and position of the user's eyes. Additionally, the device can be configured to monitor the state of a gesture from a user, the gesture including a movement by the user, such as a pinch gesture, a clap, or some other gesture. When the gesture is at a first state (e.g., the user's fingers are at a first distance as part of a pinch gesture), the device can be configured to cause display of a cursor over a first portion of content on a display of the device based on a location of the gaze and the first state of the gesture. The device is further configured to determine when the gesture moves to a second state. When the gesture moves to the second state (e.g., the user's fingers are at a second distance as part of the pinch gesture), the device can be configured to cause display of the cursor over a second portion of content on a display of the device based on the location of the gaze and the second state of the gesture. In some implementations, the second portion represents a different size than the first portion. In some implementations, the device can be configured to monitor for completion of the gesture (e.g., fingers touching as part of a pinching gesture) and provide a location of the cursor when the gesture was completed to an application.

In some aspects, the techniques described herein relate to a method including: identifying a gaze associated with a user of a device; identifying a first state of a gesture from the user; causing display of a cursor over a first portion of content on a display of the device based on the gaze and the first state of the gesture; identifying a second state of the gesture from the user; and causing display of the cursor over a second portion of the content on the display based on the gaze and the second state of the gesture, the second portion being different than the first portion.

In some aspects, the techniques described herein relate to a computing apparatus including: a computer-readable storage medium; at least one processor operatively coupled to the computer-readable storage medium; and program instructions stored on the computer-readable storage medium that, when executed by the at least one processor, direct the computing apparatus to: identify a gaze associated with a user of a device; identify a first state of a gesture from the user; cause display of a cursor over a first portion of content on a display of the device based on the gaze and the first state of the gesture; identify a second state of the gesture from the user; and cause display of the cursor over a second portion of the content on the display based on the gaze and the second state of the gesture, the second portion being different than the first portion.

In some aspects, the techniques described herein relate to a computer-readable storage medium having program instructions stored thereon that, when executed by at least one processor, cause the at least one processor to execute operations, the operations including: identifying a gaze associated with a user of a device; identifying a first state of a gesture from the user; causing display of a cursor over a first portion of content on a display of the device based on the gaze and the first state of the gesture; identifying a second state of the gesture from the user; and causing display of the cursor over a second portion of the content on the display based on the gaze and the second state of the gesture, the second portion being different than the first portion.

The details of one or more implementations are outlined in the accompanying drawings and the description below. Other features will be apparent from the description and drawings and the claims.

### BRIEF DESCRIPTION OF THE DRAWINGS

FIG. 1 illustrates a computing environment to provide a dynamic cursor based on user gaze according to an implementation.

FIG. 2 illustrates a method of operating a device to provide a dynamic cursor based on user gaze and gesture status according to an implementation.

FIG. 3 illustrates an operational scenario of providing a dynamic cursor on a device based on user gaze and gesture status according to an implementation.

FIG. 4 illustrates a method of implementing a user selection according to an implementation.

FIG. 5 illustrates an operational scenario of providing a dynamic cursor on a display based on user gaze according to an implementation.

FIG. 6 illustrates a method of operating a device to provide a dynamic cursor based on user gaze according to an implementation.

FIG. 7 illustrates an operational scenario of processing an image of an application to identify input elements available to a user according to an implementation.

FIG. 8 illustrates an operational scenario of receiving user input based on predicted available inputs for an application according to an implementation.

FIG. 9 illustrates a method of operating a device to identify user input based on predicted available inputs for an application according to an implementation.

FIG. 10 illustrates a computing system to provide a dynamic cursor according to an implementation.

### DETAILED DESCRIPTION

Computing devices, such as wearable devices and extended reality (XR) devices, provide users with an effective tool for gaming, training, education, healthcare, and more. An XR device merges the physical and virtual worlds, encompassing virtual reality (VR), augmented reality (AR), and mixed reality (MR) experiences. These devices usually include headsets or glasses equipped with sensors, cameras, and displays that track users'movements and surroundings, allowing them to interact with digital content in real time. XR devices offer immersive experiences by either completely replacing the real world with a virtual one (VR), overlaying digital information onto the real world (AR), or seamlessly integrating digital and physical elements (MR). Input to XR devices may be provided through a combination of physical gestures, voice commands, controllers, and eye movements. Users interact with the virtual environment by manipulating objects, navigating menus, and triggering actions using these input methods, which are translated by the device's sensors and algorithms into corresponding digital interactions within the XR space. However, at least one technical problem exists in providing precise and efficient inputs to the XR device using current input methodologies.

As at least one technical solution to the technical problem, an XR device or some other computing device can be configured to monitor a gaze associated with the user and a gesture provided by the user to effectively display a cursor on a display of the device. In at least one implementation, the device can be configured to monitor the gaze associated with the user. In some examples, gaze monitoring on the device uses integrated eye-tracking technology with infrared sensors and cameras to capture reflections of the user's eyes, determining the direction of the user's gaze. The device can also be configured to use gyroscopes and accelerometers to track the movement of the user's head and the corresponding gaze in some examples. The device can further be configured to monitor the state of a gesture provided by the user and update the size of a cursor displayed on the device based on the state. Examples of gestures on an XR device can include pinch-to-select, swipe-to-navigate, air tap for clicking, and multi-finger gestures for zooming or rotating objects. Gestures can be detected on the device using a combination of sensors such as cameras, depth sensors, and motion sensors that capture hand and body movements. These sensor inputs are processed by software algorithms that are configured to recognize and/or interpret specific movements or gestures.

In at least one technical solution, the device can be configured to monitor a pinch-to-select, a user clap, or some other gesture that identifies the distance between two elements of the gesture (i.e., user fingers, hands, and the like). Based on the distance between elements of the gesture and the current location of the user's gaze on the screen, the device can be configured to adjust the size of a cursor for the user. For example, when two fingers are at a first distance as part of a pinch-to-select gesture, the device can be configured to display a cursor at a first size or over a first portion of the display. The first portion of the display corresponds to the gaze identified by the device for the user. As the two fingers move or change distance, the device can be configured to update the display of the cursor to a second size that reflects the new distance between the fingers and is reflective of the user's gaze. For example, as the pinch-to-select gets closer to completion or the distance between the fingers is reduced, the size of the cursor can be reduced to correspond to the finger distance. As at least one technical effect, changing the size of the cursor based on the state of the gesture permits the user to visually identify the location of a potential input before completing the gesture.

In at least one implementation, the device can be configured to determine when the gesture is completed (e.g., fingers touch as part of a pinch-to-select gesture). In response to the completion of the gesture, the device can identify the location of the cursor at the time the gesture was completed and provide the location to an application. For example, an application may include an interface with various interactable elements, such as buttons, sliders, input fields, menus, links, or some other interactable element. Rather than permitting the application to monitor the gaze of the user, the device (or the device's operating system) can be configured to provide locations of inputs, such as coordinates relative to the application displayed. For example, the device can be configured to monitor the gaze of the user and identify when a gesture is completed indicating the selection of an interactable element. The device's operating system can provide the location of the selection relative to the application, permitting the selection of the interactable element to be processed by the application without monitoring the user's gaze. As at least one technical effect, the privacy of the user is enhanced by limiting the gaze information that is provided to the application.

In at least one technical solution to the technical problem of providing an effective cursor to a user of a device, the device can be configured to monitor the gaze of the user using at least one sensor. In some examples, the device can be configured to determine the gaze location by using infrared cameras and emitters to capture and analyze reflections from the eyes, then calculate gaze vectors to determine where the user is looking in the virtual or displayed environment. The device can further be configured to determine when the gaze focuses on a location of a display on the device for a first threshold period (i.e., time period). For example, the user viewing a button on the display for a threshold period can be identified by the device. In response to the gaze being focused on the location for the first threshold, the device can be configured to cause display of a cursor over a first portion of content on the display corresponding to the location (e.g., the button). The device can further be configured to determine when the gaze focuses on the same location for a second threshold period. In response to focusing on the location for the second threshold period, the device can be configured to cause display of the cursor over a second portion of the content on the display corresponding to the location, the second portion being different than the first portion. As an illustrative example, the user's gaze may focus on a button displayed on the device for a first threshold period, causing a first-sized cursor to be displayed for the user by the device. The user can continue to focus on the button for a second threshold period. In response to focusing on the button for the second threshold period, the device can be configured to display a second-sized cursor (e.g., a smaller form of the cursor). The cursor can be positioned based on the focus of the user (e.g., the center of the user's gaze). As the gaze continues for a longer duration, the cursor can be more refined (i.e., smaller), indicating the potential input location for the user. Once the user provides a selecting gesture (e.g., pinch-to-select), the location of the cursor can be provided to the application to provide the user's desired action (e.g., selection of a button).

In at least one technical solution to the technical problem of receiving accurate inputs on an XR device, a device can be configured to identify an image, or a screenshot, of an application displayed on the device. From the image, the device can be configured to perform a comparison of the image to at least one interface associated with another application, wherein input areas are known for the other application. For example, the device can be configured to identify shapes, positions, colors, symbols, and the like that correspond to potential inputs (e.g., the shape of a play button for a media playback application). From the comparison, the device can predict potential areas for input in the current application. Once the predictions are identified, the device can be configured to identify a gesture from a user indicative of a selection. The device can be configured to use the user's gaze and the predicted areas for input to provide a location of the selection to the application. Thus, if the user is within a threshold distance of an available input area, such as an identified button, the device can be configured to provide the location of the input (e.g., coordinates) to the application. As at least one technical effect, the operating system for the device can be responsible for monitoring the gaze and selection gestures of the user and providing the location of the selection to the application. This limits the ability of the application to track the user's gaze, providing enhanced privacy by limiting different applications from identifying information about a user's gaze.

Various embodiments of the present technology provide for a wide range of technical effects, advantages, and/or technical solutions for computing systems and components. For example, various implementations may include one or more of the following technical effects, advantages, and/or improvements: 1) non-routine and unconventional use of gaze and gesture monitoring to display a cursor for a user; 2) non-routine and unconventional operations to use a gaze focus to display a cursor for a user; 3) non-routine and unconventional operations to identify interactive components from other applications to identify likely cursor selection points for a user; and 4) non-routine and unconventional operations to limit providing gaze information to different applications.

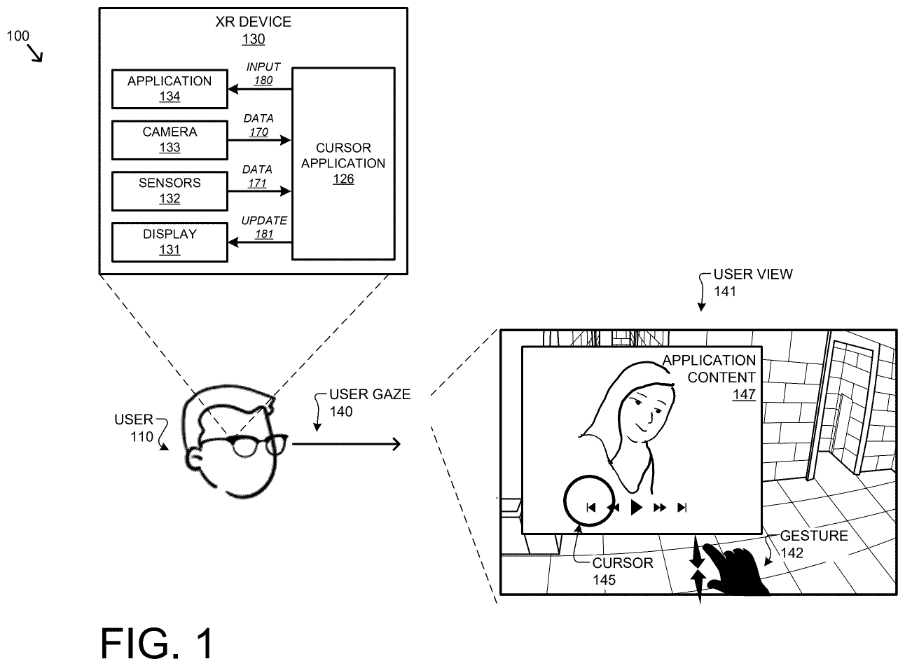

FIG. 1 illustrates a computing environment 100 to provide a dynamic cursor based on user gaze according to an implementation. Computing environment 100 includes user 110, XR device 130, user gaze 140, and user view 141. XR device 130 further includes display 131, sensors 132, camera 133, application 134, and cursor application 126. User view 141 is representative of the view for user 110 and includes gesture 142, cursor 145, and application content 147.

In computing environment 100, XR device 130 includes display 131 which is a screen or projection surface that presents immersive visual content to user 110, merging virtual elements with the real world or creating a completely virtual environment. XR device 130 further includes sensors 132 including accelerometers, gyroscopes, magnetometers, depth sensors, infrared sensors, and proximity sensors. The sensors can be used to monitor the physical movement of the user, identify depth information for other objects, identify eye movement for the user, or provide some other operation. XR device 130 also includes camera 133 that can be used for capturing the real or physical environment to overlay virtual objects (e.g., application interfaces) seamlessly and for tracking movements of user 110 and surroundings to enable accurate interaction within the augmented or virtual space. Camera 170 can be positioned as an outward view in some examples to capture the physical world associated with the user's gaze. Display 131 can receive an update 181 from cursor application 126 based on the gaze of user 110 and the gestures provided by user 110. The update can indicate the location, size, color, or some other parameter associated with cursor 145. Sensors 132 and camera 133 provide data 170-171 to cursor application 126 that can be used to update the cursor and identify user selections of content. The data can include information about the user's gaze and gestures provided by the user. Cursor application 126 can provide location information (e.g., coordinates) associated with user selections, wherein the location information is derived from the user's gestures and gaze.

In the example of computing environment 100, user view 141 is representative of the field of view for user 110. User view 141 includes application content 147 corresponding to application 134, cursor 145, and gesture 142. In at least one implementation, when user 110 initiates a gesture, cursor application 126 and XR device 130 identify the gesture 142 via sensors 132 and/or camera 133 and determine the state of gesture 142. Gesture 142 can comprise a pinching gesture, a clapping gesture, a tapping gesture (e.g., a user tapping on a table or some other object), or some other gesture with multiple states (e.g., the start of a pinch to the completion of a pinch). Cursor application 126 further identifies user gaze 140 for user 110. User gaze 140 is determined using eye-tracking sensors that detect the direction and focus of the user's eyes to understand where they are looking. User gaze 140 may further be determined based on the position of the user's head in some examples. From the state of gesture 142 and user gaze 140, cursor application 126 determines the characteristics of cursor 145, including the location of the cursor, the size of the cursor, the opacity of the cursor, or some other characteristic.

In some examples, XR device 130 and cursor application 126 can be configured to adjust the size of the cursor based on the changing state of gesture 142. For example, when in a first state, cursor application 126 can provide update 181 to display 131 to display cursor 145 at a first size. When gesture 142 moves to a second state, cursor application 126 can be configured to provide a second update that changes the size of cursor 145 from the first size to a second size. Cursor application 126 can further be configured to identify the completion of the gesture and provide a location of user gaze 140 to application 134 (input 180) at the time the gesture was completed. Although demonstrated using the size of the cursor in the previous example, cursor application 126 may adjust the opacity, the color, or some other characteristic in association with cursor 145.

In some implementations, cursor application 126 may monitor user gaze 140 to determine when the focus of the gaze satisfies a first threshold time. When user gaze 140 satisfies the first threshold time, cursor application 126 can be configured to generate a display of cursor 145 using a first size. Cursor application 126 can then be configured to determine when user gaze 140 focuses on the location for a second threshold time. In response to the gaze focusing on the location for the second threshold time, cursor application 126 can cause cursor 145 to be displayed at a second size. For example, the longer that user gaze 140 is focused on a particular portion of application content 147, the smaller the cursor will appear for the user. Cursor application 126 can further be configured to identify the completion of the gesture and provide a location of user gaze 140 to application 134 (input 180) at the time the gesture was completed. Although demonstrated using the size of the cursor in the previous example, cursor application 126 may adjust the opacity, the color, or some other characteristic in association with cursor 145.

In some examples, cursor application 126 can be configured to identify an image of application content 147 (e.g., a screenshot of application content 147). The image is then compared to one or more application interfaces associated with one or more other applications, wherein interactable or input areas are known for the other applications. Input areas may include buttons, links, sliders, or some other input area. The comparison may include comparing shapes of content, colors of content, text of content, size of content, or some other feature to determine whether an area of application content 147 is an available input area. For example, the shape of a play button can be identified based on the shape and location in application content 147. Once the available input areas are identified for application content 147, cursor application 126 identifies the completion of gesture 142 (e.g., a pinching gesture) and the location of user gaze 140 at the time gesture 142 was completed. When the location is within a threshold distance of an available input area, cursor application 126 provides the location as input 180 to application 134, permitting the desired operation of the user. In some examples, the location provided will correspond to a location in the available input area (e.g., coordinates within the parameters of a button selected by the user). When the location is not within a threshold distance of an available input area, a location may not be provided to the application. As at least one technical effect, application 134 is provided with information about the selections of the user but is not provided with information about the user's gaze.

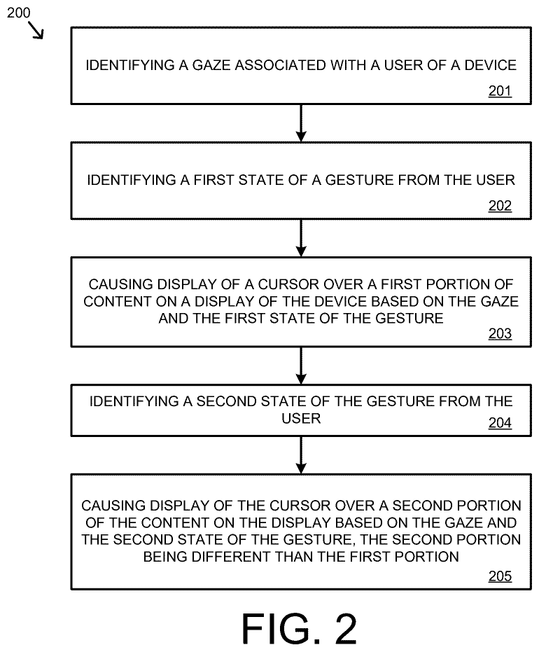

FIG. 2 illustrates a method 200 of operating a device to provide a dynamic cursor based on user gaze and gesture status according to an implementation. The steps of method 200 are described below with reference to computing environment 100 of FIG. 1.

Method 200 includes identifying a gaze associated with a user of a device at step 201 and identifying a first state of a gesture from the user at step 202. The gaze of the user can be determined using eye-tracking and head motion sensors that detect the direction and focus of the user's eyes to understand where they are looking. Gestures can be tracked by the device using a combination of cameras and motion sensors that capture hand (or other extremity) movements and positions to interpret and respond to user inputs. In some implementations, the gesture comprises a pinch-to-select gesture, a clap, or some other gesture with multiple states before completing the selection. For example, the device can identify the first state based on the location and distance of two fingers as part of a pinching gesture.

Method 200 further includes causing display of a cursor over a first portion of content on a display of the device based on the gaze and the first state of the gesture at step 203. A cursor may comprise a circle, pointer, or some other graphical object overlaid on the content of the display to indicate the location of the gaze of the user. Method 200 also includes identifying a second state of the gesture from the user at step 204. The second state can correspond to the distance between two elements of the gesture (i.e., fingers as part of a pinching gesture). For example, the first state may correspond to the fingers being at a first distance, while the second state may correspond to the fingers being at a second distance. Method 200 further includes causing display of the cursor over a second portion of the content on the display based on the gaze and the second state of the gesture, the second portion being different than the first portion at step 205. In some examples, the focus of the cursor remains the same (i.e., based on the user gaze), but the size may get smaller or larger based on the state of the gesture.

As an illustrative example from computing environment 100, XR device 130 can be configured to identify a first state of gesture 142 and user gaze 140 and generate cursor 145 with a first size. XR device 130 can then monitor the state of gesture 142 (i.e., the pinching gesture) and update the size of the cursor 145 to reflect the state of the gesture. As the fingers get closer, cursor 145 can get smaller in size, and as the fingers move further apart, cursor 145 can get larger. When gesture 142 is completed, which is detected by the fingers touching, XR device 130 can identify the location of user gaze 140 at the time of completion. The location can then be provided to application 134 associated with application content 147. In some implementations, application 134 is not provided with information about the cursor location but is provided with the selection locations. The technical effect is that the application is limited in identifying information about the user gaze.

Although demonstrated as adjusting the size of the cursor, other characteristics of the cursor can be adjusted in addition to or in place of the size. The other characteristics can include the opacity of the cursor, the shape of the cursor, the color of the cursor, or some other characteristic.

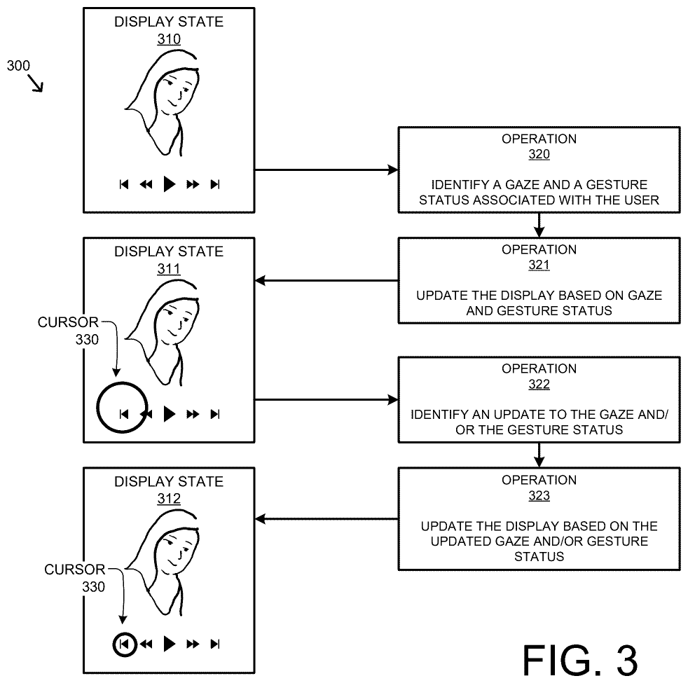

FIG. 3 illustrates an operational scenario 300 of providing a dynamic cursor on a device based on user gaze and gesture status according to an implementation. Operational scenario 300 includes display states 310-312 and operations 320-323.

In operational scenario 300, operation 320 identifies a gaze and gesture state associated with the user when viewing display state 310. The gaze is determined using one or more sensors that determine the direction of the user's eyes. The sensors may include infrared sensors, cameras, gyroscopes, or some other sensors. The gesture state is identified using a combination of sensors like accelerometers, gyroscopes, and cameras, which capture the movement and position of the user's hands or other input devices. The captured data is then processed using one or more algorithms or models or predefined motion patterns to recognize and interpret specific gestures.

From the gaze and gesture status of the user, operation 321 updates the display. Referring to the example in operational scenario 300, display state 310 does not display a cursor. However, in display state 311, cursor 330 is added. In some implementations, the size of cursor 330 is based at least in part on the state of completion for the gesture. For example, when the gesture is in a first state (e.g., a first distance of fingers for a pinching gesture), the device can be configured to provide a first-sized cursor. When the gesture is in a second state (e.g., a second distance of fingers for a pinching gesture), the device can be configured to provide a second-sized cursor.

After being placed in display state 311, operation 322 identifies an update to the gaze and/or the gesture status for the user. The update can include a change in gaze location, a change in the status of the gesture (e.g., moving fingers or other objects associated with the gesture), or some other update. Operation 323 then updates the display based on the updated gaze and/or gesture status. In the update demonstrated as part of display state 312, operation 323 displays cursor 330 as a smaller version than 311 while maintaining the location based on the gaze of the user. Although not depicted in operational scenario 300, in some examples, the user's gaze may change location while the gesture state remains the same. Consequently, the device can be configured to move the cursor on the display while maintaining the size of the cursor.

Although demonstrated in the example of the operational scenario as changing the size of the cursor, a device can be configured to modify other characteristics associated with a cursor based on the user's gaze and gesture. These modifications can be made in addition to or in place of modifying the size of the cursor. The modifications to the cursor can include adjusting the color of the cursor based on the gesture state, adjusting the opacity of the cursor based on the gesture state, adjusting the shape of the cursor based on the gesture state, or providing some other modification to the cursor.

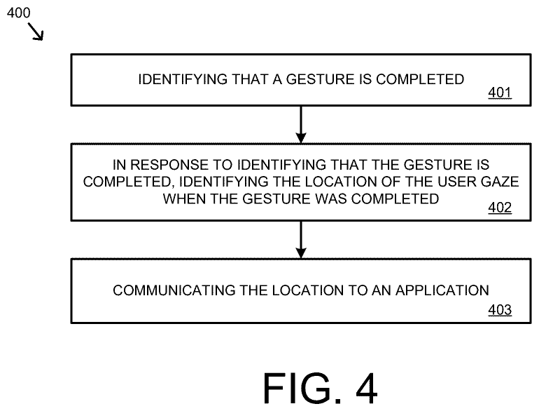

FIG. 4 illustrates method 400 of implementing a user selection according to an implementation. Method 400 can be performed by an XR device, such as XR device 130 of FIG. 1, or by some other computing device.

Method 400 includes identifying that a gesture is completed at step 401. The gesture can include a pinching gesture, a clapping gesture, a tapping gesture, or some other gesture associated with the distance of two objects (e.g., fingers in the case of a pinching gesture or a finger and a table in the example of a tapping gesture). The gesture can be completed when the two objects for the gesture touch in some examples (e.g., fingertips touching as part of a pinching gesture). The gesture can be tracked by the device using a combination of cameras and motion sensors that capture the movement and positions of objects (such as fingers, arms, and hands) to interpret and respond to user inputs. In response to identifying that the gesture is completed, method 400 further includes identifying the location of the user gaze when the gesture was completed at step 402. In some implementations, the device monitors the gaze using eye-tracking and/or head motion sensors that detect the position and movement of the user's eyes relative to the display. This data is processed to determine where on the display the user is looking or focusing.

Method 400 further includes communicating the location to an application at step 403. In some implementations, the location includes a coordinate associated with the location relative to the display or the window of the application. In some implementations, a first application (or an operating system) of the device can be configured to monitor the gaze and gestures of the user and provide input locations to a second application being displayed on the device. The technical effect is that gaze information is limited for the second application.

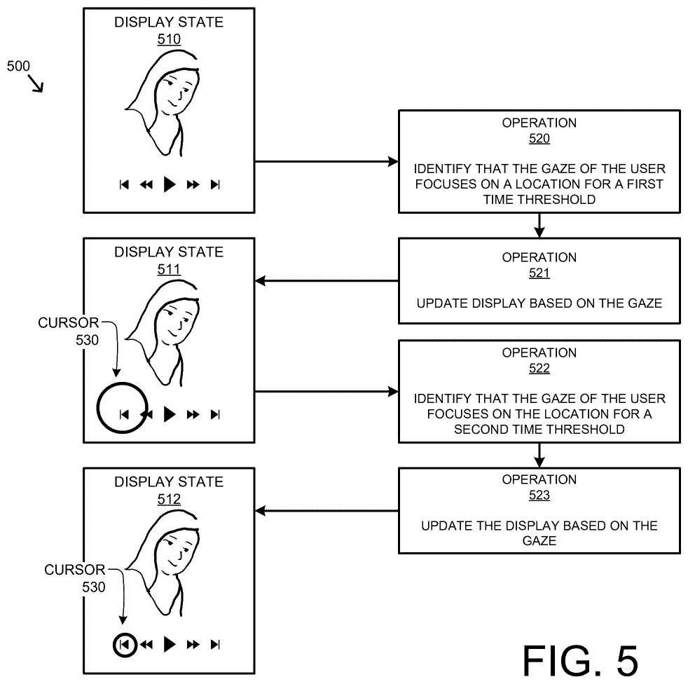

FIG. 5 illustrates an operational scenario 500 of providing a dynamic cursor on a display based on user gaze according to an implementation. Operational scenario 500 includes display states 510-512 representative of the display at different times on a device and operations 520-523 that are performed by the processing system of the device. Operational scenario 500 further includes cursor 530.

Operational scenario 500 includes identifying that the gaze of the user focuses on a location of the display for a first time threshold at operation 520. The gaze can be monitored via one or more cameras or other sensors that detect the direction of the gaze and the relation of the gaze to the display of the device. The device can then be configured to determine whether the gaze lingers or focuses within a threshold for the threshold time. Once the gaze focuses for the first time threshold, operation 521 is performed. Operation 521 updates the display based on the gaze. In the present example, display state 510 is transitioned to display state 511 which adds a cursor 530 of a first size to the display corresponding to the user's gaze.

Once in display state 511, operation 522 is performed. Operation 522 identifies when the gaze of the user focuses on the location for a second time threshold. In response to satisfying the second time threshold, the device is configured to update the display based on the gaze and the satisfied threshold at step 523. In display state 512, cursor 530 is updated from display state 511 to reduce the size from a first size to a second size. Although demonstrated as reducing or changing the size of cursor 530, the device can also be configured to change the opacity, the color, the shape, or some other characteristic with cursor 530.

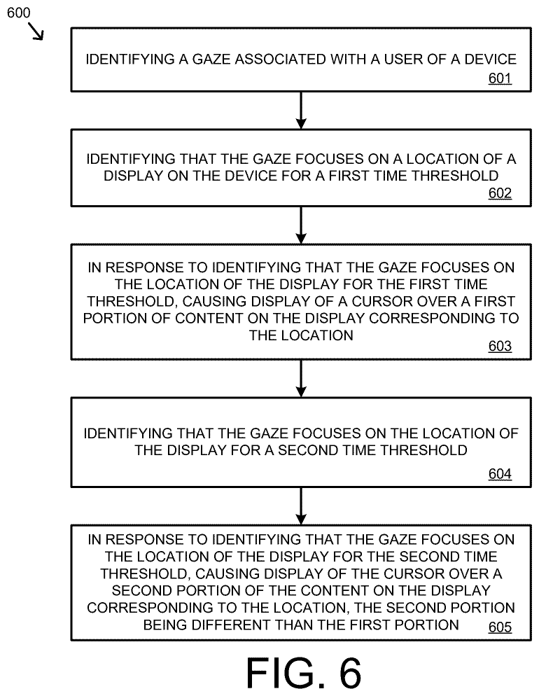

FIG. 6 illustrates a method 600 of operating a device to provide a dynamic cursor based on user gaze according to an implementation. Method 600 can be performed by an XR device or some other device with the sensors and other functionality to perform the operations described herein.

Method 600 includes identifying a gaze associated with a user of the device at step 601 and identifying that the gaze focuses on a location of a display on the device for a first threshold at step 602. In some examples, the location may include a threshold area or region of the screen, where the gaze must be focused within the area or region (e.g., an area of pixels). This permits the device to compensate for the user's eye jitter or other eye functions. In response to identifying that the gaze focuses on the location of the display for the first threshold, method 600 further includes causing display of a cursor over a first portion of content on the display corresponding to the location at step 603. For example, if the user focuses on a play button for a threshold period, the device can be configured to overlay a cursor on the play button per the user's gaze.

Method 600 further includes identifying that the gaze focuses on the location of the display for a second time threshold at step 604. In response to determining that the gaze focuses on the location of the display for the second time threshold, method 600 further provides for causing display of the cursor over a second portion of the content on the display corresponding to the location at step 605, the second portion being different than the first portion. Returning to the example of the play button, a device can be configured to provide a first cursor of a first size over the play button when the user's gaze focuses on a location for a first threshold time. Once the focus extends to a second threshold time, the device can be configured to reduce the size of the cursor to indicate the duration. Once the user provides a selection gesture (e.g., pinching selection, poking selection, or some other gesture), the device can be configured to provide the location of the gaze at the time of gesture to the application. Advantageously, the user's gaze information may not be provided to the application. Instead, another application of the operating system of the device can monitor the gaze and provide the location of a selection after the selection is made.

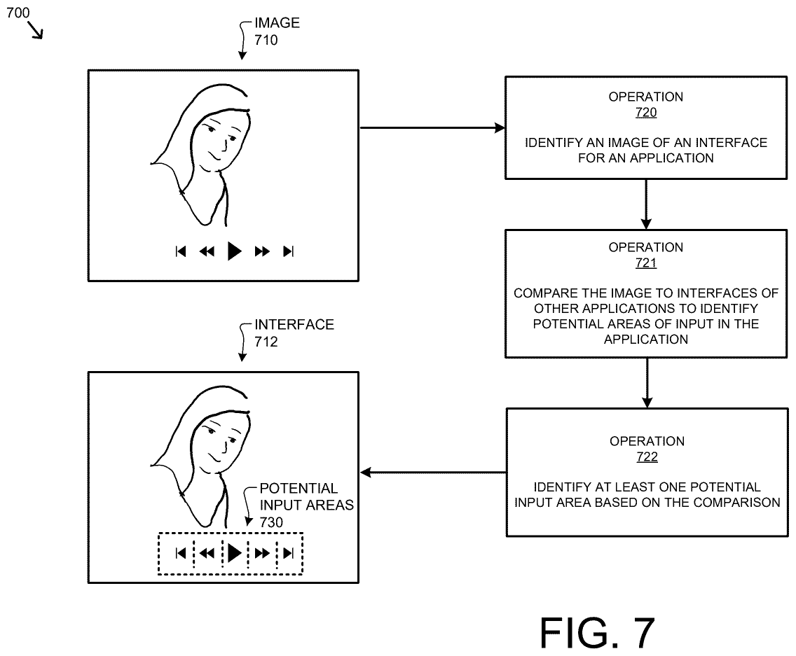

FIG. 7 illustrates an operational scenario 700 of processing an image of an application to identify input elements available to a user according to an implementation. Operational scenario 700 includes image 710, operations 720-722, interface 712, and potential input areas 730. Operations 720-722 can be performed by an XR device or some other computing device.

In operational scenario 700, operation 720 identifies image 710 associated with a visual interface for an application. The visual interface is a designed graphical user interface (GUI) that users interact with on the device to provide the desired operation of the application. After the image is identified, the device compares the image to one or more interfaces (e.g., user interfaces) of other applications to identify potential or available areas of input in the application using operation 721. In some implementations, the input areas for the other applications are known and information about shapes, word choice, colors, size, and other characteristics from the known input areas can be compared to the image of the current application to identify the available input portions on the current application. Once compared, the device can be configured to identify at least one potential input area based on the comparison during operation 722. For example, portions of the image that satisfy at least one criterion can be classified as an input area (e.g., match color, shape, and size). Here, the device identifies potential input areas 730 as part of interface 712 for the application.

In at least one implementation, the device can be configured with a machine learning model that identifies patterns and relationships between the image and the interfaces of the at least one other application. The machine learning model can be taught by adjusting parameters via iterations of identifying available input areas in test applications by comparing images of the test applications to interfaces of known applications. The parameters are adjusted to identify the potential input areas from the image data. Once the potential input areas are identified, the device can be configured to use the potential input areas to receive user input.

As an example, a device can be configured to compare image 710 to known interfaces associated with one or more other applications. From the comparison, the device can determine that playback (i.e., play, pause, fast-forward, and the like) input elements or areas are identified in the image. This is demonstrated in operational scenario 700 as potential input areas 730 in interface 712. When the user provides a selection gesture, such as a pinching gesture or voice command, the device can identify the current gaze of the user and determine whether the gaze is focused on a display location that is within a threshold input area. If the gaze is within the threshold distance, then the device can provide a location consistent with the input area. For example, if the user's gaze is focused on a play button, then the device can provide the application with a location (e.g., display coordinate) associated with the play button. In some examples, the device may further provide a cursor or otherwise highlight the input area determined by the device to provide feedback to the user.

In some implementations, an operating system or a second application on the device can monitor the gaze of the user and determine a selection location based on gaze and gesture. Once the location (e.g., display coordinate) is determined, the operating system or the second application can provide the location to the application, permitting the application to act on the selection.

In some implementations, rather than determining the potential input locations locally at the end user device, the available locations can be determined using one or more second computers, such as server computers. The one or more second computers can identify images of visual application interfaces and determine potential input areas based on a comparison to input areas known for other applications.

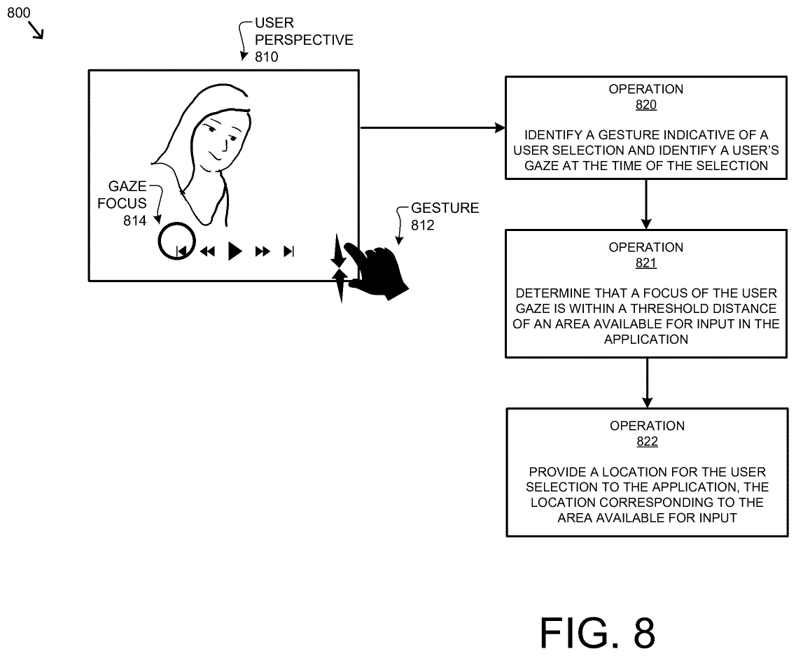

FIG. 8 illustrates an operational scenario 800 of receiving user input based on predicted available inputs for an application according to an implementation. Operational scenario 800 includes user perspective 810, gaze focus 814, gesture 812, and operations 820-822. Operational scenario 800 can be performed by an XR device or some other computing device.

For operational scenario 800, a device can be configured to identify a gesture 812 indicative of a user selection and identify a user's gaze at the time of the selection using operation 820. The gesture may include touch, tap, pinch, grab, voice commands, and hand or finger point-and-hold actions. The gaze is determined using sensors that monitor the movement of the eyes and/or head of the user to identify where the user is looking. The device can further be configured to provide operation 821 to determine that a gaze focus 814 of the user's gaze is within a threshold distance of an area available for input in the application.

In some implementations, the application can indicate input areas within the application interface that are available to the user. For example, the application can include or indicate that one or more areas in the display of the application are available for input. From the information, the device can determine whether gaze focus 814 is within a threshold distance of an available input area at the time the gesture was made.

In some implementations, the device can be configured to capture an image of the visual interface of the application and compare the image to the visual interfaces of other applications where the available input areas are known. The comparison can identify similarities between the shapes of elements (e.g., buttons), colors of elements, size of elements, text of elements, and the like to identify potential input areas for the application demonstrated as part of user perspective 810.

Once the device determines that the focus of the gaze is within a threshold distance of an available input area, the device can be configured to provide a location for the user selection to the application, the location corresponding to the area available for input using operation 822. In some implementations, the location corresponds to gaze focus 814, which is the intersection of the gaze and the display of the device. In some examples, the location comprises a coordinate associated with gaze focus 814 on the display. In some implementations, the device can separate an application from observing the user's gaze. Instead, the operating system or a second application will monitor the user gaze and selection locations. Once selected, the location of the selection on the screen is provided to the application.

In some implementations, the operations of operational scenario 800 can be combined with the operations of method 200 of FIG. 2. In at least one example, a cursor can be displayed for the user that is updated based on the state of the gesture. For example, a device can be configured to display a cursor at a first size when a pinching gesture is at a first state and display the cursor at a second size when the pinching gesture is at a second state. When the gesture is complete, the device can be configured to identify the gaze of the user and determine whether the gaze is within a threshold distance of an available input area. If the gaze is within a threshold distance of an available input area, the device can be configured to provide the location of the gaze or a location in the available input area (e.g., coordinate of a button, link, or other input area) to the application. If the gaze is not within a threshold distance of an available input area, the device can be configured to not provide a location of the input to the application. The technical effect permits a user to view a more precise cursor based on gesture state and provide input to available input areas identified for the application. Advantageously, even when the user's gaze is not directly viewing the input area, a location within the input area can be provided to the application to provide the desired result.

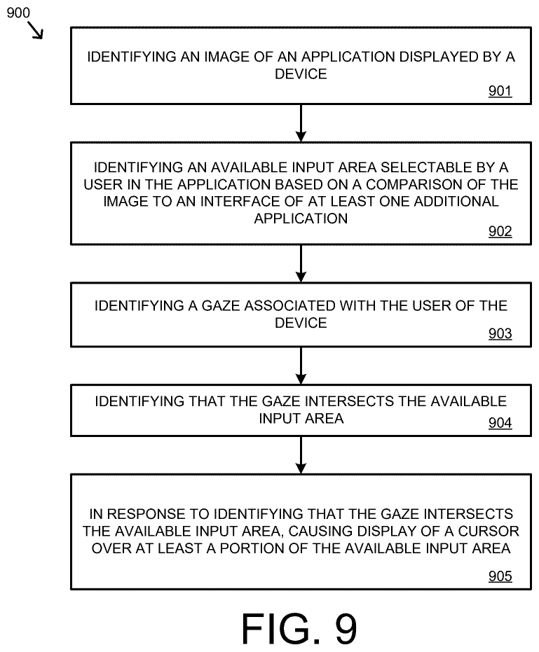

FIG. 9 illustrates a method 900 of operating a device to identify user input based on predicted available inputs for an application according to an implementation. The steps of method 900 can be implemented on an XR device or some other computing device.

Method 900 includes identifying an image of an application displayed by a device at step 901. Method 900 further includes identifying an available input area selectable by a user in the application based on a comparison of the image to one or more interfaces of at least one additional application at step 902, wherein available input areas are known for the one or more interfaces. In some implementations, the device may perform a model that compares characteristics in the image to characteristics in the one or more interfaces. The characteristics may include shape, color, text, location, or some other characteristic. When an area for the current application satisfies at least one criterion, the area can be classified as an area for input. In at least one implementation, the device can be configured with a machine learning model that identifies patterns and relationships between the image and the interfaces of the at least one other application. The machine learning model can be taught by adjusting parameters via iterations of identifying available input areas in applications by comparing images of the applications to interfaces of known applications.

Method 900 further includes identifying a gaze associated with a user of the device at step 903 and identifying that the gaze intersects the available input area at step 904. Method 900 also provides for, in response to identifying that the gaze intersects the available input area, causing the display of a cursor over at least a portion of the available input area at step 905. As an illustrative example, a user can focus on a button displayed by the device for a threshold period, the button identified as an input area for the application. In response to the focus intersecting the button for the threshold period (identified via one or more sensors), the device can be configured to display a cursor over at least a portion of the button.

Although demonstrated in the previous example as identifying a gaze of the user and displaying a cursor, similar operations can be performed to identify a gesture from the user and apply the action in the corresponding application. For example, an operating system or first application can monitor the gaze of the user and determine when the user makes a selection gesture (e.g., voice gesture or pinch gesture). In response to the gesture, the first application can determine that the user's gaze is within a threshold distance of an input area and provide a location corresponding to the available input area to a second application. The second application can comprise a content playback application, image editing application, or some other application. In some examples, the second application is provided with the location of the selection (e.g., a coordinate) and is not provided with information about the user gaze. Advantageously, the user's gaze can be kept private from the second application.

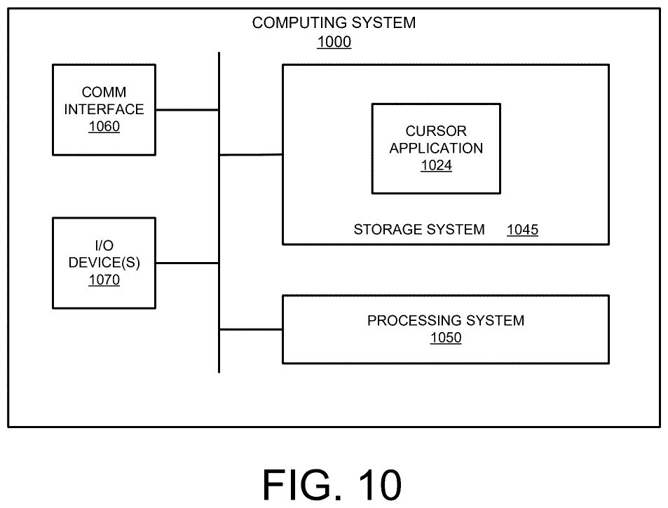

FIG. 10 illustrates a computing system to provide a dynamic cursor according to an implementation. Computing system 1000 is representative of any computing system or systems with which the various operational architectures, processes, scenarios, and sequences disclosed herein for dynamically displaying a cursor may be implemented. Computing system 1000 is an example of an XR device or some other computing device capable of the operations described herein. Computing system 1000 includes storage system 1045, processing system 1050, communication interface 1060, and input/output (I/O) device(s) 1070. Processing system 1050 is operatively linked to communication interface 1060, I/O device(s) 1070, and storage system 1045. Communication interface 1060 and/or I/O device(s) 1070 may be communicatively linked to storage system 1045 in some implementations. Computing system 1000 may further include other components such as a battery and enclosure that are not shown for clarity.

Communication interface 1060 comprises components that communicate over communication links, such as network cards, ports, radio frequency, processing circuitry (and corresponding software), or some other communication devices. Communication interface 1060 may be configured to communicate over metallic, wireless, or optical links. Communication interface 1060 may be configured to use Time Division Multiplex (TDM), Internet Protocol (IP), Ethernet, optical networking, wireless protocols, communication signaling, or some other communication format-including combinations thereof. Communication interface 1060 may be configured to communicate with external devices, such as servers, user devices, or some other computing device.

I/O device(s) 1070 may include peripherals of a computer that facilitate the interaction between the user and computing system 1000. Examples of I/O device(s) 1070 may include keyboards, mice, trackpads, monitors, displays, printers, cameras, microphones, external storage devices, sensors, and the like.

Processing system 1050 comprises microprocessor circuitry (e.g., at least one processor) and other circuitry that retrieves and executes operating software (i.e., program instructions) from storage system 1045. Storage system 1045 may include volatile and nonvolatile, removable, and non-removable media implemented in any method or technology for storage of information, such as computer-readable instructions, data structures, program modules, or other data. Storage system 1045 may be implemented as a single storage device but may also be implemented across multiple storage devices or sub-systems. Storage system 1045 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 1050 is typically mounted on a circuit board that may also hold the storage system. The operating software of storage system 1045 comprises computer programs, firmware, or some other form of machine-readable program instructions. The operating software of storage system 1045 comprises cursor application 1024. The operating software on storage system 1045 may further include an operating system, utilities, drivers, network interfaces, applications, or some other type of software. When read and executed by processing system 1050 the operating software on storage system 1045 directs computing system 1000 to operate as a computing device as described herein. In at least one implementation, the operating software can provide method 200 described in FIG. 2, method 600 described in FIG. 6, or method 900 described in FIG. 9 as well as any other operation to dynamically change a cursor on a display of a device based on a user's gaze and a user's gesture.

In at least one example, cursor application 1024 is configured to identify a gaze associated with a device user and identify a first state of a gesture from the user. Cursor application 1024 is further configured to cause display of a cursor over a first portion of content on a display of the device based on the gaze and the first state of the gesture. For example, computing system 1000 and the operating software thereon can be configured to identify a first state of a pinching gesture (e.g., distance between fingers) and the location of the gaze from the user. Once determined a cursor can be displayed based on the state of the gesture and the location of the gaze.

After displaying the cursor over the first portion, cursor application 1024 is further configured to identify a second state of the gesture from the user and cause the display of the cursor over a second portion of the content on the display based on the gaze and the second state of the gesture, the second portion being different than the first portion. In some implementations, the second portion is smaller than the first. For example, when the gesture is in a first state the cursor is overlaid at a first-sized portion of the display, and when the gesture is in a second state the cursor is overlaid over a second-sized portion of the display. At least one technical effect is that as the gesture nears completion (e.g., completes a pinching gesture), the cursor may more accurately indicate the location of the selection by the user.

In at least one implementation, cursor application 1024 is configured to direct processing system 1050 to identify a gaze associated with a device user and identify that the gaze focuses on a location for a first period or threshold. In response to identifying that the gaze focuses on the location of the display for the first period, cursor application 1024 is configured to display a cursor over a first portion of content on the display corresponding to the location. Cursor application 1024 can further be configured to direct processing system 1050 to identify that the gaze focuses on the location of the display for a second period or threshold and causes the display of the cursor over a second portion of the content on the display corresponding to the location in response to identifying that the gaze focuses on the location for the second period. In some examples, the second portion is smaller than the first portion, while both are based on the location of the user's gaze.

In at least one implementation, cursor application 1024 directs processing system 1050 to identify an image (i.e., screenshot) of an application displayed by a device and identify a component or selectable area by a user in the application based on a comparison of the image with interfaces of at least one additional application. In some examples, the comparison may include a model that identifies similar characteristics in the image to input areas in the known interfaces. The characteristics may include shape, size, text, or some other characteristic associated with an input area. For example, a device can identify a play button in a media playback application based on the shape of the button, based on the location of the button in the image of the interface, or based on some other factor. The device can classify the area associated with the button as an input area.

Once an area is classified as an input area, cursor application 1024 can be configured to direct processing system 1050 to identify a selection gesture from a user. The selection gesture can comprise a pinching gesture, a point-to-select gesture, a voice gesture, or some other gesture. In response to the gesture, cursor application 1024 can be configured to identify the gaze of the user and determine whether the focus of the gaze is within a threshold distance of the input area. When the focus is within the threshold distance of the input area, the cursor application will provide a location corresponding to the input area. As an example of a button, when the user makes a selection gesture, computing system 1000 can determine whether the user's gaze is within a threshold distance of the button (e.g., within the pixels displayed for the button). If the user is within the threshold, a location associated with the button is provided to the application, permitting the user to select the button.

Clause 1. A method comprising: identifying a gaze associated with a user of a device; identifying a first state of a gesture from the user; causing display of a cursor over a first portion of content on a display of the device based on the gaze and the first state of the gesture; identifying a second state of the gesture from the user; and causing display of the cursor over a second portion of the content on the display based on the gaze and the second state of the gesture, the second portion being different than the first portion.

Clause 2. The method of clause 1 further comprising: identifying that the gesture is completed; and in response to identifying that the gesture is completed, providing a location of the cursor to an application when the gesture was completed.

Clause 3. The method of clause 2, wherein the gesture comprises a pinching gesture, a clapping gesture, or a tapping gesture.

Clause 4. The method of clause 1, wherein the second portion is a different size than the first portion.

Clause 5. The method of clause 1, wherein identifying a gaze associated with the user comprises tracking eye movement of the user via at least one sensor on the device.

Clause 6. The method of clause 1 further comprising: identifying an area of an application available for input from the user; identifying that the gesture is completed; determining that a focus of the gaze is within a threshold distance of the area at a time that the gesture was completed; and in response to determining that the focus of the gaze is within a threshold distance of the area at the time the gesture was completed, providing a location corresponding to the area to the application.

Clause 7. The method of clause 6, wherein the area includes a button or a link.

Clause 8. The method of clause 6, wherein identifying the area of the application available for input from the user comprises: identifying an image of an interface for the application; performing a comparison of the image to at least one additional interface for at least one additional application, wherein at least one area available for input is known for the at least one additional interface; and identifying the area of the application available for input from the user based on the comparison.

Clause 9. A computing apparatus comprising: a computer-readable storage medium; at least one processor operatively coupled to the computer-readable storage medium; and program instructions stored on the computer-readable storage medium that, when executed by the at least one processor, direct the computing apparatus to: identify a gaze associated with a user of a device; identify a first state of a gesture from the user; cause display of a cursor over a first portion of content on a display of the device based on the gaze and the first state of the gesture; identify a second state of the gesture from the user; and cause display of the cursor over a second portion of the content on the display based on the gaze and the second state of the gesture, the second portion being different than the first portion.

Clause 10. The computing apparatus of clause 9, wherein the program instructions further direct the computing apparatus to: identify that the gesture is completed; and in response to identifying that the gesture is completed, provide a location of the cursor to an application when the gesture was completed.

Clause 11. The computing apparatus of clause 10, wherein the gesture comprises a pinching gesture, a clapping gesture, or a tapping gesture.

Clause 12. The computing apparatus of clause 9, wherein the second portion is a smaller version of the first portion.

Clause 13. The computing apparatus of clause 9, wherein identifying a gaze associated with the user comprises tracking eye movement of the user via at least one sensor on the device.

Clause 14. The computing apparatus of clause 9, wherein the program instructions further direct the computing apparatus to: identify an area of an application available for input from the user; identify that the gesture is completed; determine that a focus of the gaze is within a threshold distance of the area at a time that the gesture was completed; and in response to determining that the focus of the gaze is within a threshold distance of the area at the time the gesture was completed, provide a location corresponding to the area to the application.

Clause 15. The computing apparatus of clause 14, wherein the area includes a button or a link.

Clause 16. The computing apparatus of clause 14, wherein identifying the area of the application available for input from the user comprises: identifying an image of an interface for the application; performing a comparison of the image to at least one additional interface for at least one additional application, wherein at least one area available for input is known for the at least one additional interface; and identifying the area of the application available for input from the user based on the comparison.

Clause 17. A computer-readable storage medium having program instructions stored thereon that, when executed by at least one processor, cause the at least one processor to execute operations, the operations comprising: identifying a gaze associated with a user of a device; identifying a first state of a gesture from the user; causing display of a cursor over a first portion of content on a display of the device based on the gaze and the first state of the gesture; identifying a second state of the gesture from the user; and causing display of the cursor over a second portion of the content on the display based on the gaze and the second state of the gesture, the second portion being different than the first portion.

Clause 18. The computer-readable storage medium of clause 17, wherein the operations further comprise: identifying that the gesture is completed; and in response to identifying that the gesture is completed, providing a location of the cursor to an application when the gesture was completed.

Clause 19. The computer-readable storage medium of clause 17, wherein the operations further comprise: identifying an area of an application available for input from the user; identifying that the gesture is completed; determining that a focus of the gaze is within a threshold distance of the area at a time that the gesture was completed; and in response to determining that the focus of the gaze is within a threshold distance of the area at the time the gesture was completed, providing a location corresponding to the area to the application.

Clause 20. The computer-readable storage medium of clause 19, wherein the operations further comprise: identifying an image of an interface for the application; performing a comparison of the image to at least one additional interface for at least one additional application, wherein at least one area available for input is known for the at least one additional interface; and identifying the area of the application available for input from the user based on the comparison.

In this specification and the appended claims, the singular forms “a,” “an” and “the” do not exclude the plural reference unless the context dictates otherwise. Further, conjunctions such as “and,” “or,” and “and/or” are inclusive unless the context dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections, or logical connections may be present in a practical device. Moreover, no item or component is essential to the practice of the implementations disclosed herein unless the element is specifically described as “essential” or “critical.”

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, the use of terms such as up, down, top, bottom, side, end, front, back, etc. herein are used concerning a currently considered or illustrated orientation. If they are considered concerning another orientation, such terms must be correspondingly modified.

Further, in this specification and the appended claims, the singular forms “a,” “an”and “the”do not exclude the plural reference unless the context dictates otherwise. Moreover, conjunctions such as “and,” “or,” and “and/or” are inclusive unless the context dictates otherwise. For example, “A and/or B”includes A alone, B alone, and A with B.

Although certain example methods, apparatuses, and articles of manufacture have been described herein, the scope of coverage of this patent is not limited thereto. It is to be understood that the terminology employed herein is to describe aspects and is not intended to be limiting. On the contrary, this patent covers all methods, apparatus, and articles of manufacture fairly falling within the scope of the claims of this patent.

1. A method comprising:
identifying a gaze associated with a user of a device;
identifying a first state of a gesture from the user, the first state identified based on a first distance between a first element of the gesture and a second element of the gesture;
causing display of an indicator over a first portion of content on a display of the device based on the gaze and the first state of the gesture;
identifying a second state of the gesture from the user, the second state identified based on a second distance between the first element of the gesture and the second element of the gesture, the second distance being different than the first distance; and
causing display of the indicator over a second portion of the content on the display based on the gaze and the second state of the gesture, the second portion of the content being different than the first portion of the content.

2. The method of claim 1 further comprising:
identifying that the gesture is completed; and
in response to identifying that the gesture is completed, providing a location of the indicator to an application when the gesture was completed.

3. The method of claim 2, wherein the gesture comprises a pinching gesture, a clapping gesture, or a tapping gesture.

4. The method of claim 1, wherein the first portion of the content comprises a first size based on the first distance, and wherein the second portion of the content comprises a second size based on the second distance, the second size different than the first size.

5. The method of claim 1, wherein identifying the gaze associated with the user comprises tracking eye movement of the user via at least one sensor on the device.

6. The method of claim 1 further comprising:
identifying an area of an application available for input from the user;
identifying that the gesture is completed;
determining that a focus of the gaze is within a threshold distance of the area at a time that the gesture was completed; and
in response to determining that the focus of the gaze is within the threshold distance of the area at the time the gesture was completed, providing a location corresponding to the area to the application.

7. The method of claim 6, wherein the area includes a button or a link.

8. The method of claim 6, wherein identifying the area of the application available for input from the user comprises:
identifying an image of an interface for the application;
performing a comparison of the image to at least one additional interface for at least one additional application, wherein at least one area available for input is known for the at least one additional interface; and
identifying the area of the application available for input from the user based on the comparison.

9. A computing apparatus comprising:
a non-transitory computer-readable storage medium;
at least one processor operatively coupled to the non-transitory computer-readable storage medium; and
program instructions stored on the non-transitory computer-readable storage medium that, when executed by the at least one processor, direct the computing apparatus to:
identify a gaze associated with a user of a device;
identify a first state of a gesture from the user, the first state identified based on a first distance between a first element of the gesture and a second element of the gesture;
cause display of an indicator over a first portion of content on a display of the device based on the gaze and the first state of the gesture;
identify a second state of the gesture from the user, the second state identified based on a second distance between the first element of the gesture and the second element of the gesture, the second distance being different than the first distance; and
cause display of the indicator over a second portion of the content on the display based on the gaze and the second state of the gesture, the second portion of the content being different than the first portion of the content.

10. The computing apparatus of claim 9, wherein the program instructions further direct the computing apparatus to:
identify that the gesture is completed; and
in response to identifying that the gesture is completed, provide a location of the indicator to an application when the gesture was completed.

11. The computing apparatus of claim 10, wherein the gesture comprises a pinching gesture, a clapping gesture, or a tapping gesture.

12. The computing apparatus of claim 9, wherein the first portion of the content comprises a first size based on the first distance, and wherein the second portion of the content comprises a second size based on the second distance, the second size different than the first size.

13. The computing apparatus of claim 9, wherein identifying the gaze associated with the user comprises tracking eye movement of the user via at least one sensor on the device.

14. The computing apparatus of claim 9, wherein the program instructions further direct the computing apparatus to:
identify an area of an application available for input from the user;
identify that the gesture is completed;
determine that a focus of the gaze is within a threshold distance of the area at a time that the gesture was completed; and
in response to determining that the focus of the gaze is within the threshold distance of the area at the time the gesture was completed, provide a location corresponding to the area to the application.

15. The computing apparatus of claim 14, wherein the area includes a button or a link.

16. The computing apparatus of claim 14, wherein identifying the area of the application available for input from the user comprises:
identifying an image of an interface for the application;
performing a comparison of the image to at least one additional interface for at least one additional application, wherein at least one area available for input is known for the at least one additional interface; and
identifying the area of the application available for input from the user based on the comparison.

17. A non-transitory computer-readable storage medium having program instructions stored thereon that, when executed by at least one processor, cause the at least one processor to execute operations, the operations comprising:
identifying a gaze associated with a user of a device;
identifying a first state of a gesture from the user, the first state identified based on a first distance between a first element of the gesture and a second element of the gesture;
causing display of an indicator over a first portion of content on a display of the device based on the gaze and the first state of the gesture;
identifying a second state of the gesture from the user, the second state identified based on a second distance between the first element of the gesture and the second element of the gesture; and
causing display of the indicator over a second portion of the content on the display based on the gaze and the second state of the gesture, the second portion of the content being different than the first portion of the content.

18. The non-transitory computer-readable storage medium of claim 17, wherein the operations further comprise:
identifying that the gesture is completed; and
in response to identifying that the gesture is completed, providing a location of the indicator to an application when the gesture was completed.

19. The non-transitory computer-readable storage medium of claim 17, wherein the operations further comprise:
identifying an area of an application available for input from the user;
identifying that the gesture is completed;
determining that a focus of the gaze is within a threshold distance of the area at a time that the gesture was completed; and
in response to determining that the focus of the gaze is within the threshold distance of the area at the time the gesture was completed, providing a location corresponding to the area to the application.

20. The non-transitory computer-readable storage medium of claim 19, wherein the operations further comprise:
identifying an image of an interface for the application;
performing a comparison of the image to at least one additional interface for at least one additional application, wherein at least one area available for input is known for the at least one additional interface; and
identifying the area of the application available for input from the user based on the comparison.
